(19) United States
(12) Patent Application Publication
(10) Pub. No.: US 2019/0147463 A1
(43) Pub. Date: May 16, 2019

(54) SYSTEMS AND METHODS FOR PLANOGRAM GENERATION FOR A FACILITY

(71) Applicant: Walmart Apollo, LLC, Bentonville, AR (US)

(72) Inventor: Somedip Karmakar, Kolkata (IN)

(21) Appl. No.: 15/928,897

(22) Filed: Mar. 22, 2018

(30) Foreign Application Priority Data
Nov. 10, 2017 (IN) 201711040143

(51) Int. Cl. G06Q 30/02; G06N 99/00

(52) U.S. Cl. CPC G06Q 30/0202; G06N 99/005

(57) ABSTRACT

A system for planogram generation for a facility is described. The system includes a computing device configured to execute a planogram generation (PG) module that allocates items in a product category to shelf positions. The PG module generates, based on the allocation, a first planogram for each item in the product category. The PG module also generates after a predefined time period an updated second planogram based on an updated allocation. The PG module compares the second planogram with the first planogram and identifies one or more changes. The planogram module transmits at least one alert identifying the one or more changes in the second planogram.

### CROSS-REFERENCE TO RELATED PATENT APPLICATIONS

This application claims priority to Indian Patent Application No. 201711040143, filed on Nov. 10, 2017, the content of which is hereby incorporated by reference in its entirety.

### BACKGROUND

Retailers are concerned wish the placement of products on shelving areas. Retailers expend great time and effort in considering where and how to place products on limited store shelves. The profitability of a store is in part dependent on an optimal placement of products for perusal by customers. If a customer cannot find a product, or a product does not catch his or her eye, or if there is insufficient stock on the shelf to meet demand, then a sale may be lost.

### BRIEF DESCRIPTION OF THE DRAWINGS

To assist those of skill in the art in making and using a planogram generation system and associated methods, reference is made to the accompanying figures. The accompanying figures, which are incorporated in and constitute a part of this specification, illustrate one or more embodiments of the invention and, together with the description, help to explain the invention. Illustrative embodiments are shown by way of example in the accompanying drawings and should not be considered as limiting. In the figures:

FIGS. 1A-1F depict illustrations associated with an illustrative embodiment;

FIG. 2 illustrates an exemplary network environment suitable for a planogram generation system, in accordance with an exemplary embodiment;

FIG. 3 is a flowchart illustrating an exemplary method for generating a planogram using the planogram generation system, in accordance with an exemplary embodiment;

FIG. 4 is a schematic view of a central computing system used in the planogram generation system, in accordance with an exemplary embodiment; and

FIG. 5 is a flowchart depicting an exemplary sequence of steps for generating planograms in an exemplary embodiment.

### DETAILED DESCRIPTION OF EMBODIMENTS

Some retailers have several thousand categories of products with millions of items. Each store often has a unique customer base with unique buying patterns. Therefore, product placement may be crucial for a retailer. However, it is difficult to manually manage item assortment and product placement on shelves for each store. Furthermore, making assortment decisions at an aggregated level may cause a loss of important information.

System and methods for planogram generation for a facility are described herein. The system includes a physical facility with shelves configured to hold items. The system further includes a computing device equipped with a memory and a processor and configured to execute a planogram generation (PG) module. The PG module programmatically identifies optimal shelving locations for items, including items that should be adjacently placed, and generates a planogram, as further described herein.

The PG module when executed obtains shelving information, including shelf positions in a facility, from the memory. The PG module assigns an importance value to each shelf position for a product category of interest. In one embodiment, the assignment of the importance value by the PG module is based on at least one of historical sales data for the product, demographics of target customers, an average height of a prime customer group for a product category, a position of a shelf, a depth and a width of a shelf, and past sales data of items in various shelf positions. Accordingly, the shelf positions on the shelves are ranked in an order of importance.

The PG module forecasts a demand for an upcoming predefined time period for each item in the product category. The demand is based on historical sales data, such as point of sales data. In an exemplary embodiment, the PG module forecasts demand for the next month for each item in the product category by retrieving at least three years of point of sales data from the memory, and using at least one of a SARIMAX analysis or a Holt-Winters method on the sales data to forecast sales.

The system further determines required facings for the items. Required facings are the horizontal facings of an item, which includes a number of instances of the same item present on the shelves and facing the customers. Vertical facings and depth facings are based on the construction of the shelves and cannot be modified. Required facings for each item are calculated in terms of the forecasted demand of the item. The required horizontal facings=max{1.5 case pack,(forecasted demand in 3.5 days of supply (DOS)+safety stock)/(vertical facings*depth facings)}, where case pack is the number of items in a warehouse pack, days of supply are a number of days between two successive replenishment cycles (usually taken as 3.5 for fast moving consumer goods (FMCG) items), and safety stock is a number of items to be kept on the shelf to prevent out-of-stock situations. Usually the case pack, days of supply, and safety stocks are constraints to be satisfied to modify the required facings from the forecasted demand

The PG module identifies optimal item pair adjacencies for each item in the product category based on cross-space elasticity. Optimal item pair adjacencies are items that, when paired adjacent to each other, influences (e.g., raises) demand for the items. Cross-space elasticity describes an impact of a change in the space assigned to one item, on the demand of other items. In an exemplary embodiment, the PG module identifies optimal item pair adjacencies by (1) performing, for each item in the product category, a multivariate regression on facings allocated to the items in the category, (2) utilizing partial regression coefficients from the multivariate regression to identify the best complimentary item, where a coefficient sign is used to identify a set of complimentary products and a magnitude determines a best compliment, (3) creating an item-item adjacency matrix with the partial regression coefficients as estimates of cross-space elasticity to form a directed graph with the items as nodes and the edge-weights as their corresponding coefficients, and (4) determining optimal item pair adjacencies using a greedy algorithm on the directed graph, where adjacent items are displayed in the planogram.

The PG module also determines a performance score for each item in the category based on the historical sales data and item loyalty scores. The PG module allocates, based on the optimal item pair adjacencies, item performance, and shelf position importance value, the items to the shelf positions classified by importance. Once the positions are identified on the shelves, horizontal facings are obtained among the items allocated to each shelf. For example, in an exemplary embodiment, the PG module determines starting and ending coordinates on the shelf positions obtained for each item with required facings, and the number of facings on the shelf space, to draw an optimal planogram. Each item is given three attributes: the starting x and y coordinates in the shelf space and a horizontal space allocated to the item. Using these attributes, the PG module generates, based on the allocation, a first planogram for the items in the product category using an image plotting tool e.g. JDA. A planogram is a diagram or model that indicates the placement of retail products on shelves.

The PG module programmatically generates a planogram for each product category in the store based on the allocation and the forecast demand After a pre-defined amount of time, such as but not limited to, every month, the PG module performs a second of allocation of items to shelf space as described above taking into account updated input parameters reflecting changes occurring since the first allocation. The system then generates an updated second planogram based on the second allocation and newly computed item demand

The PG module compares the updated planogram with the existing planogram using a matching algorithm to identify one or more changes. In an exemplary embodiment, the existing planogram is compared with the updated planogram using one or more of data on the item positions or image processing to determine and compare the item co-ordinate positions of the planograms.

If the PG module identifies one or more changes based on the comparison, the PG module transmits at least one alert to an individual associated with the facility, such as a store employee, identifying the one or more changes in the updated planogram. For example, in one embodiment, the PG module transmits at least one alert to a store manager for changing product placement and/or transmits at least one alert to a replenishment manager for changing an order quantity. The alert may, for example, include an image of the updated planogram.

In some embodiments, the PG module compares the existing planogram with the updated planogram to determine if there is a statistically significant change in sales between the two planograms using machine learning. When there is a statistically significant change, the PG module transmits an alert.

In some embodiments, the system further includes a mobile application executing on a mobile computing device typically associated with a store employee. The PG module transmits the at least one alert to the mobile application In some embodiments, the alert includes an image of the planogram and/or a required order quantity to meet a forecasted demand

In an additional embodiment, the system further includes a drone configured to capture images/pictures of the items on the shelves to obtain an existing item arrangement in the store. The images may be used to compare the updated planogram with the shelves existing arrangement to identify one or more changes. Obtaining and comparing the existing arrangement from the store may provide a better understanding regarding implementation and execution in the store. In other embodiments, a portable camera may be used instead of a drone.

In one illustrative embodiment, a system determines item placement for a sample category, “yogurt”, in a store where a modular layout is 5 shelves allocated to the category. Each shelf is 32 feet. Based on an average item dimension, each shelf is divided into 10 spots (average item dimension*average facings=3 feet), for 50 total shelf positions. An importance of each shelf position is determined based on a past 3 years of sales. For example, shelf position 1 of a second shelf has 5 different items in different modular relays. Let Y=the sales/footage of the items selling in the shelf position, alpha=the importance of the shelf position, beta(i)=the importance of the ith item, and delta(i) be the interaction effect of item i and the shelf position. The system uses the equation: Y˜alpha+beta(i)*(units sold per week for ith item)+delta(i)*(units sold per week for ith item)+error, and minimizes over the sum of squares of the error, to obtain the estimated values for the shelf position importance alpha. Assuming, for example, that the equation after estimation is Y˜0.13+0.56*item 1−0.23*item 2+0.45*item 3−0.7*interaction (item 1)+ . . . , then the importance of the shelf position is given by 0.13. This process is repeated for all the shelf positions to obtain the importance value for each position.

The system computes the demographic importance of each shelf position by combining the sales information with demographics of a household shopping in the category. For example, using a random forest model, the system identifies important demographic features (i.e., female gender, children less than 10 years old, large family size, etc.). Using, for example, the top five demographics, the system determines a share of sales from the 50 shelf positions to identify the most important shelf positions from the key demographics. For example, using the children's demographics, the system may determine that the first shelf position to the fourth shelf position and the tenth shelf position on the fourth shelf are driving the sales, and that these are suitable for children single pack yogurt items. Using the share of sales, the system adds the importance of these shelf positions. For example, if 30% of sales occurs from the second shelf position of the fourth shelf, and the initial importance of this spot is 0.06, then the demographic importance amounts to 0.3+0.06=0.36.

The system then ranks the shelf positions according to the adjusted importance. For example, in the scenario, there are five broader yogurt groups: generic, children single pack, children multipack, premium ,and ethnic. The number of shelf positions allocated to each of these groups are 25, 7, 9, 6, and 3, respectively. Each of the shelf positions are ranked according to their shelf importance. If it is a generic shelf position, the system only uses the initial importance. Otherwise, for each of the demographic segments, the system uses a combination of the initial importance and the demographic importance to arrive at the ranking of the shelf positions.

In the illustrative embodiment discussed above, based on past sales data (for example, 3 years of monthly sales data), the system determines the demand forecast for the next month using SARIMAX and/or Holt-Winters algorithms For example, let Y(t) be sales of a particular item in time point t, then Y(t)=T(t)+S(t)+beta*X(t)+p(t−1)*Y(t−1)+p(t−2)*Y(t−2)+ . . . +e(t)+q(t)*e(t−1)+ . . . , where T(t) is the trend, S(t) is the seasonal effect, X(t) is the matrix of independent variables, which can include day of week, holiday, promotion, and other factors that can influence the sales, and e(t) is the error at time t. Assuming that the random errors e(t) follow multivariate normal with mean 0 and variance sigma&*Î2, the system solves the equation to determine the estimates of the parameters beta's, p's, and q's.

Using the estimated values of the parameters, the system determines the forecasted value of the sales for Y(t+1), i.e., for the next month. For example, for a particular item, ABC Blueberry Yogurt, the system determines that the forecasted sales for the next month is S580.

The system further determines the required facings for the item using the constraints of (1) days of supply, (2) safety stock, and (3) case pack. For example, in the scenario, the system computes an average days of supply (DOS) as 3.5 days, maintains one (1) day of supply worth of safety stock, and a constraint of 1.5 case pack to ensure direct truck to store delivery. The system determines the required facings for the item ABC Blueberry Yogurt as follows. For example, the price per item is $2.50, the monthly units sold=232, and the 3.5 DOS=27. The vertical and depth facings are, for example, 4 and 5 respectively and cannot be modified. The pack size is 4. So 1.5 case pack=6 and safety stock=8. The required facings=ceiling (max(1.5 case packs (3.5 DOS+safety stock))/vertical*depth facings)=ceiling (max(6(27+8))/(4*5))=2. Thus, the system determines that the required horizontal facings for this item is 2.

The system next identifies which products should be placed together. For simplicity, the example assumes there are only 5 items in the category. The system creates 5 multivariate regressions for each of the items. Let the sales of item i be denoted by s(i), and the facings be denoted by f(i). For the first item the regression equation is s(1)=alpha(1)+beta(11)* f(1)+beta(12)*f(2)+ . . . +beta(15)* f(5)+error(1). Minimizing the sum of squares of the error terms, the system determines estimates of beta(11), . . . ,beta(15). Similarly the 4 other regression equations are solved.

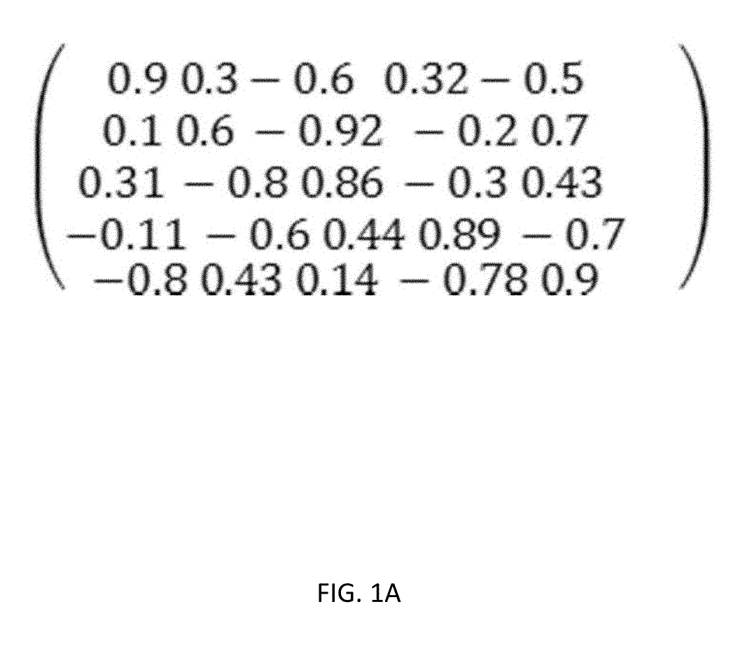

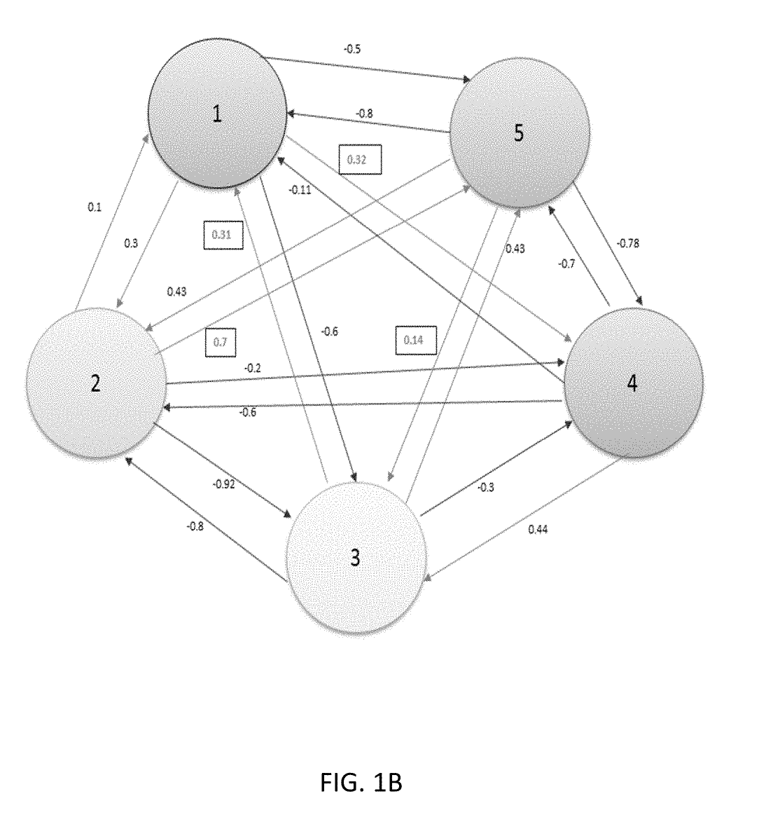

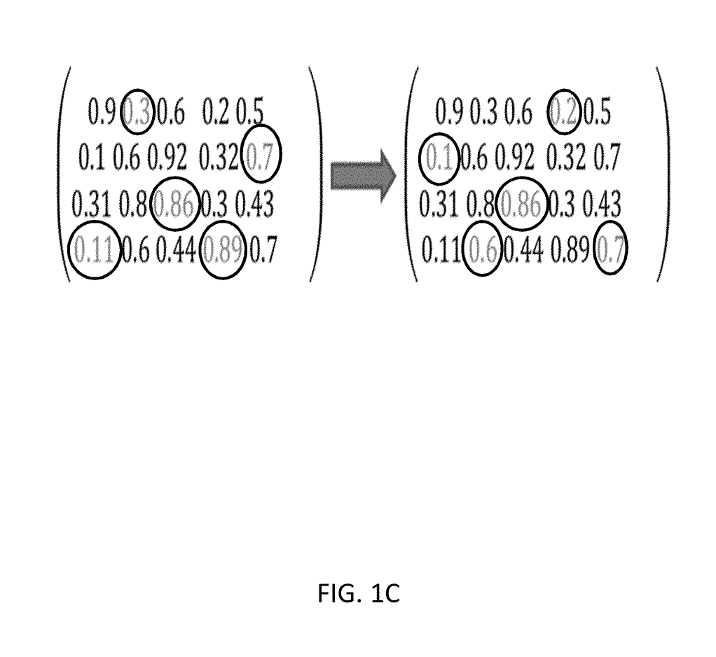

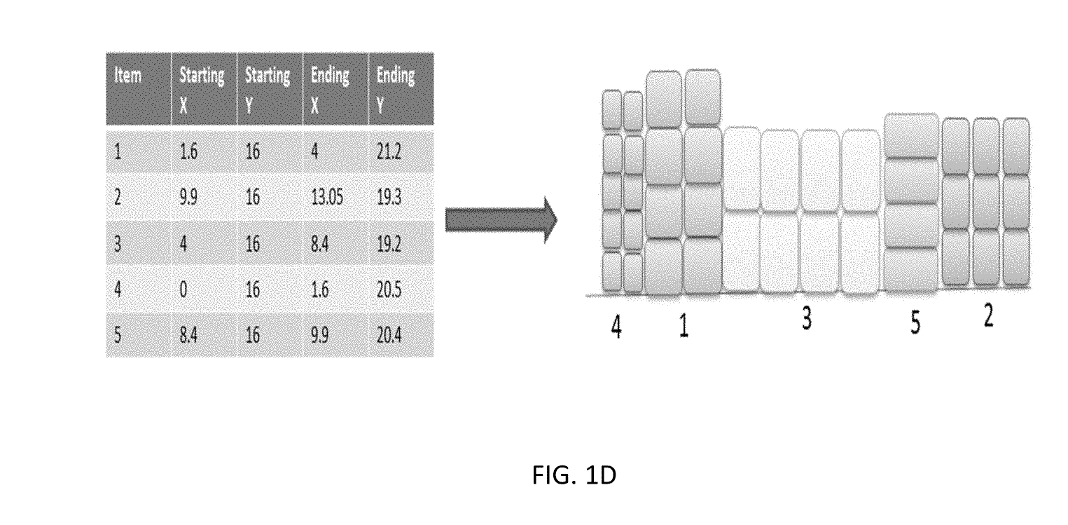

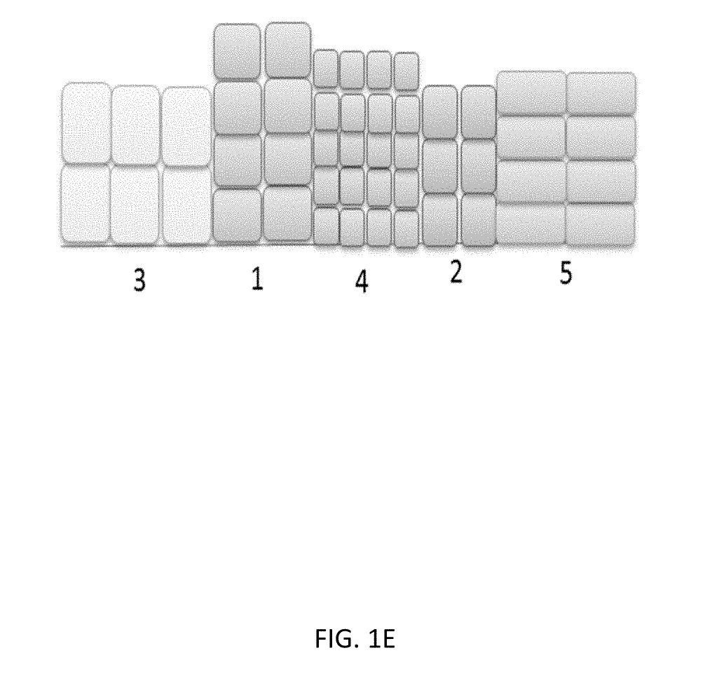

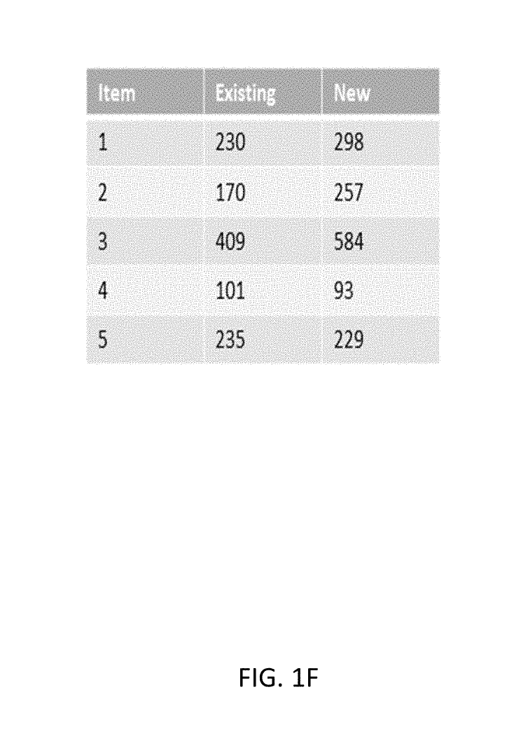

For example, let the first solved equation be s(1)=57.8+0.9*f(1)+0.3*f(2)−0.6*f(3)+0.32*f(4)−0.5*f(5). The item-item adjacency matrix is formed with the (I,j)th element corresponding to the jth partial regression coefficient from the ith equation, i.e., beta(ij). In the example, the first row of the matrix is 0.9,0.3,−0.6,0.32,−0.5). The item-item adjacency matrix is shown in FIG. 1A. A positive sign of the coefficient indicates that the sales of the item I will increase when the facings of item j is increased. A negative sign implies that increasing the facings of item j will decrease the sales of item i. The magnitude implies that for unit change in facings of item j, how many units of sales is gained or lost by item i.

Using the item-item adjacency matrix, the system forms a directed network graph with the edge weights from item i to item j corresponding to the (i,j)th element in the matrix. The system uses a greedy algorithm to determine the optimal item adjacency. The system determines the optimal item adjacency by (1) determining the largest edge from the graph and the adjacency list starts from the origin of that edge, (2) determining the maximum edge among all those origination from the destination of the first edge, (3) if an edge is found which is positive in direction continuing the graph path in the same manner consecutively connecting the maximum positive edges, (4) if an edge from a particular node I has already appeared in the selected graph, then the path cannot go back to that same node (i.e., the graph is acyclic), and (5) if from a node all the new edges are negative, then end the path and continue the same procedure with the sub-graph containing the remaining nodes. The order of item adjacency is shown in FIG. 1B.

In this example, the greedy algorithm chooses the order of item adjacency as (2,5,3,1,4). The system starts with the maximum edge weight of 0.7 connecting 2 to 5, and then keep on taking the maximum acyclic edges from 5 to 3(0.14), 3 to 1 (0.31) and 1 to 4(0.32).

The system ranks the items based on sales performance measures and loyalty scores. In one example, the sales performance measures are sales per week and units sold per week, aggregated over a defined time period, such as, but not limited to, the past 3 years. An item loyalty is defined as a proportion of repurchase occasions, where a customer repurchased a same item. For example, a customer makes purchases in the store 10 times and buys only 2 items in the following order: 1, 1, 2, 2, 2, 2, 1, 1, 1, and 2. The number of repurchase occasions for item 1 are five and the customer repurchases item 1 three times. The loyalty score of the customer for item 1=3 repurchases/5 repurchase occasions=0.6. The loyalty scores of item 1 are calculated for all the customers and aggregated at store-item level to get an overall loyalty score for each item. The system ranks all the items based on a combined score of their sales performance and item loyalty.

The system then allocates the items to suitable shelf positions. A cost matrix of the allocation problem is a m×n matrix where m is the number of shelf positions (50 in the example) and n is the total number of items (for example, 70 items), where the (I,j)th element is the ratio of the importance score of the ith shelf position and the combined performance score of the jth item. The cost matrix can be divided into several smaller sub-matrices depending on the number of demographic sub-groups (5 in the example). Each of the items in the sub-matrix is allocated a particular shelf position, starting from the lowest element in the matrix and then moving along the path obtained from the graph. The total cost of the allocation is determined and the objective is to minimize the total cost, by choosing varied starting points.

For example, there may be 4 shelf positions A, B, C, and D, and 5 items 1,2, . . . ,5. Assuming these belong to the same demographic sub-group, the cost matrix is calculated using the item performance and shelf position importance, as shown by FIG. 1C.

The item adjacency list obtained from the directed graph is (2, 5, 3, 1, 4). The system starts by putting item 2 in its most favorable spot shelf (determined by the shelf position importance), and receives the assignment indicated by circles in FIG. 1C, whereby the total cost becomes 2.86. This cost is minimized by altering the shelf allocations but keeping the item adjacency fixed. Thus, after optimization the system determines that (1,B), (2,D), (3,C), (4,A), (5,D) is the optimal allocation, shown in FIG. 1C.

The shelf position allocations give an approximate location for each of the items. Multiple items can be allocated to a same shelf position. In that case, the order of the items should be the same as that obtained from the optimal sub-graph path.

Continuing with the description of this illustrative embodiment, the item facings, item dimensions (facing length), and the coordinates of the shelf positions are used to determine the start and end coordinates of the items. The entire space is 32 feet wide and 40 feet tall, the lower-most shelf starts from (0,0) and goes up to (32,0) in horizontal area and (0,6),(32,6) in vertical area. The second from lower shelf starts from (0,8),(32,8) to (0,14),(32,14) and so on. In the example, the shelf positions A-D go from (0,16), (15,16) up to (0,22),(15,22). Based on the facings allocation, described earlier, the required optimal horizontal facings for each of the 5 items are (2, 3, 4, 2, 1) respectively, and their facing lengths are (1.2, 1.05, 1.1, 0.8, 1.5) respectively. The fixed vertical depths and vertical heights of items are (4, 3, 2, 5, 4) and (1.3, 1.1, 1.5, 0.9, 1.1) respectively for the 5 items. The optimal coordinates for the 5 items are obtained. Using the (X,Y) coordinates of the items, the system uses an image plotting tool to generate the planogram shown in FIG. 1D.

In one embodiment, the system can test whether projected sales will increase with an optimized planogram. For example, an existing layout in a store may be as depicted in FIG. 1E and the system may perform a hypothesis testing that projected sales will increase significantly with a new optimal planogram. The projected sales/unit from the sales demand forecast is multiplied by the existing units in capacity and adjusted by the interaction effect of the shelf position. This is a proxy for the sales without making any change to the shelf layout. Similarly, the projected sales is multiplied by the facing information from the optimal planogram and adjusted by the interaction effect of the shelf positions which are optimal, to get the projected sales from the new planogram, as shown in FIG. 1F. The system may perform a paired t test to determine whether the increase in sales is significant. The test statistic is given by (mean (new sales)−mean (old sales))/(standard deviation/(number of items−1)), which follows a t distribution with 4 degrees of freedom. In this example t-stat>95th percentile of t4, so with 95% confidence, the sales with the new planogram will significantly exceed the sales of the existing layout. An automated alert may then be sent to an individual, such as the store manager, suggesting that they change the layout based on the new planogram.

The planogram generation system described herein programmatically optimizes the product placement process and customizes the process for each store. While some known systems generate planograms for product categories using a manual process, given operational constraints and execution issues, providing a customized recommendation for each store is not possible using a manual process. As a result, product placement decisions are conventionally made at an aggregated level. Further, since current product planning may be made after prolonged time periods (e.g., once a year), if a sudden change in demand patterns occurs, it is often not possible to change the placement and mix of products and a and loss of sales may occur. The planogram generation system described herein provides a programmatic solution to optimize planogram generation to account for rapidly changing conditions and transmit alerts regarding changes to planograms to distributed devices associated with individuals connected to the facilities represented by the planograms.

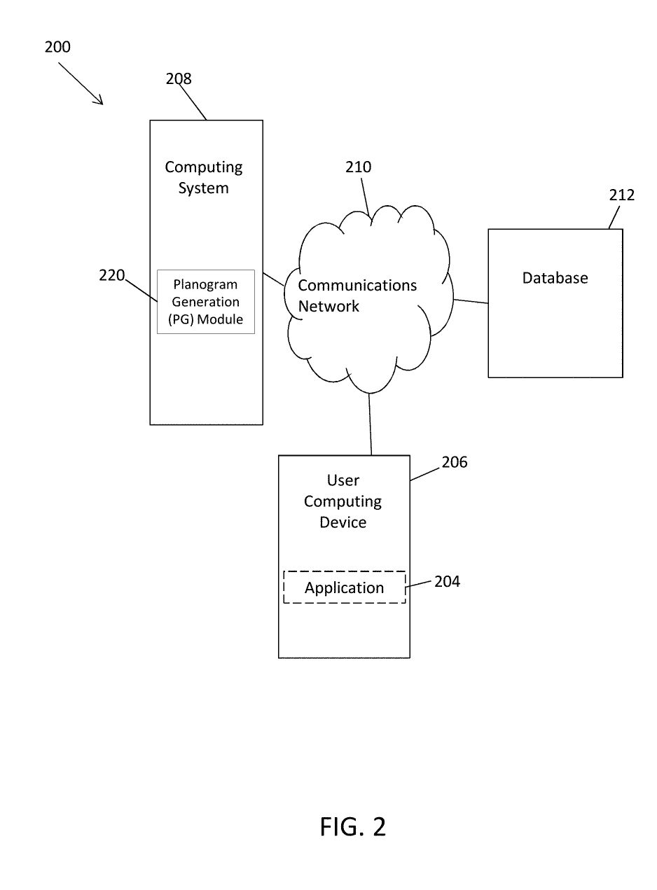

FIG. 2 illustrates an exemplary network environment 200 suitable for the planogram generation system, in accordance with an exemplary embodiment. The environment 200 includes a computing system 208 executing a planogram generation (PG) module 220. The computing system 208 is communicatively coupled, via communications network 210, to a database 212. Although the database 212 is shown as remote from computing system 208, in alternative embodiments database 212 can exist within computing system 208. The database 212 stores information including, but not limited to, information regarding shelves, product categories and items, historical sales data, and customer demographic information for different products. The database 212 may also store rankings of shelf positions, item adjacencies, required facings, and generated planograms for one or more facilities.

In some embodiments, the computing system 208 is communicatively coupled, via a wireless network 210, to an application 204 installed on a user computing device 206. For example, the user computing device 206 may be a desktop computing device or a mobile computing device such as a tablet or a smartphone. The application 204 receives automated alerts and/or planograms which are displayed on an interface of the user computing device 206. In other embodiments, the planogram generation module 220 transmits the automated alerts using electronic mail or text messages to a designated individual.

The communications network 210 can be any network over which information can be transmitted between devices communicatively coupled to the network. For example, the communication network 210 can be the Internet, an Intranet, virtual private network (VPN), wide area network (WAN), local area network (LAN), and the like.

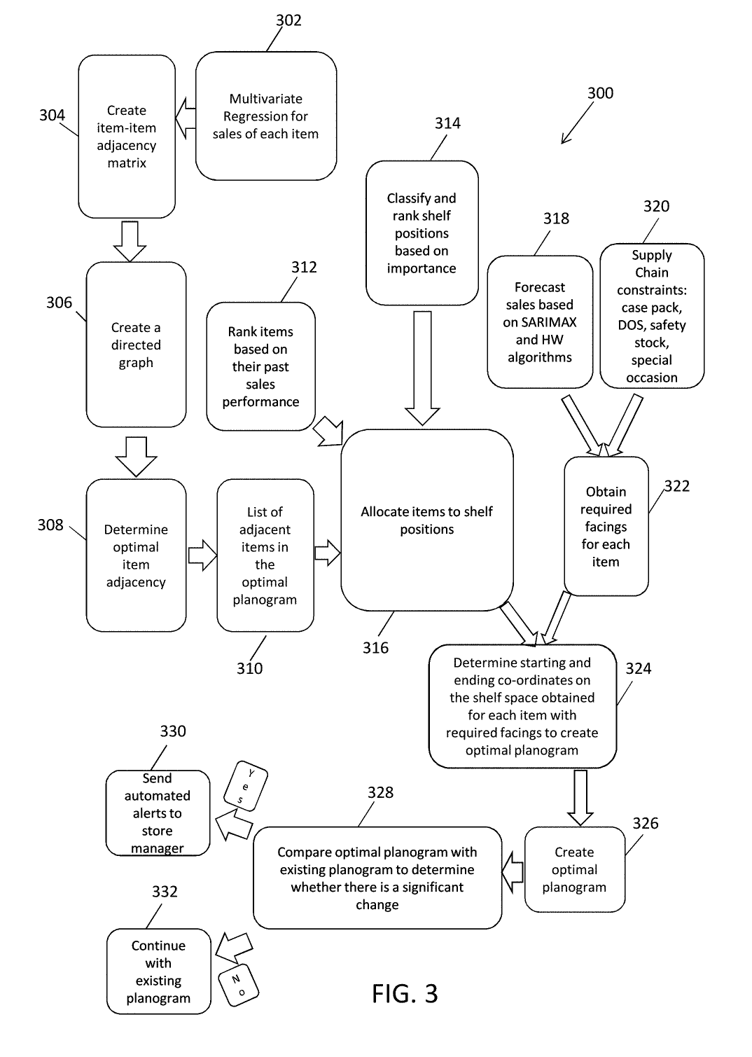

FIG. 3 is a flowchart illustrating an exemplary method 300 for planogram generation in an exemplary embodiment. At step 302, to identify optimal item pair adjacencies, the system uses multivariate regression for sales of each item, taking into account the facings of the items. At step 304, the system creates an item-item adjacency matrix with the partial regression coefficients as estimates of cross-space elasticity. At step 306, the system creates a directed graph with the items as nodes and the edge-weights being corresponding coefficients. At step 308, the system determines optimal item adjacency by the shortest path on the directed graph taken by a greedy algorithm with maximum positive edge weight on the graph. At step 310, the system creates a list of the optimal item adjacency (e.g., a list of adjacent items) for a planogram. At step 312, the system ranks item performance based on past sales performance.

At step 314, the system classifies and ranks shelf positions based on importance of customer preference based on category item information, past sales in shelf segments, and prime customer demographics, such as height, age, and gender, for the item category. At step 316, the system allocates items to shelf positions.

At step 318, the system forecasts next month's sales based on SARIMAX and/or Holt-Winters algorithms. In an exemplary embodiment, the system uses 3 years of transaction history. At step 320, the system obtains supply chain constraints, such as case pack, DOS, safety stock, and special occasions. At step 322, the system obtains required facings for each item.

At step 324, the system determines starting and ending coordinates on the shelf space for each item allocated to a shelf position with a required facing. The item positions are determined by the method explained herein. The system allocates the coordinates to the items. At step 326, the system creates an optimal planogram based on the allocation of the items which is adjusted based on the forecast demand reflected by the required facings calculation.

At step 328, the system compares the new planogram with an existing planogram to determine whether there is a statistically significant change. For example, the system may test overall sales amount with the control set being forecasted sales for next month based on the existing planogram and the test set being forecasted sales for next month adjusted by the new facings and item positions. If a significant change is determined, at step 330, the system transmits one or more automated alerts. If a significant change is not determined, at step 332, the system continues with the existing planogram.

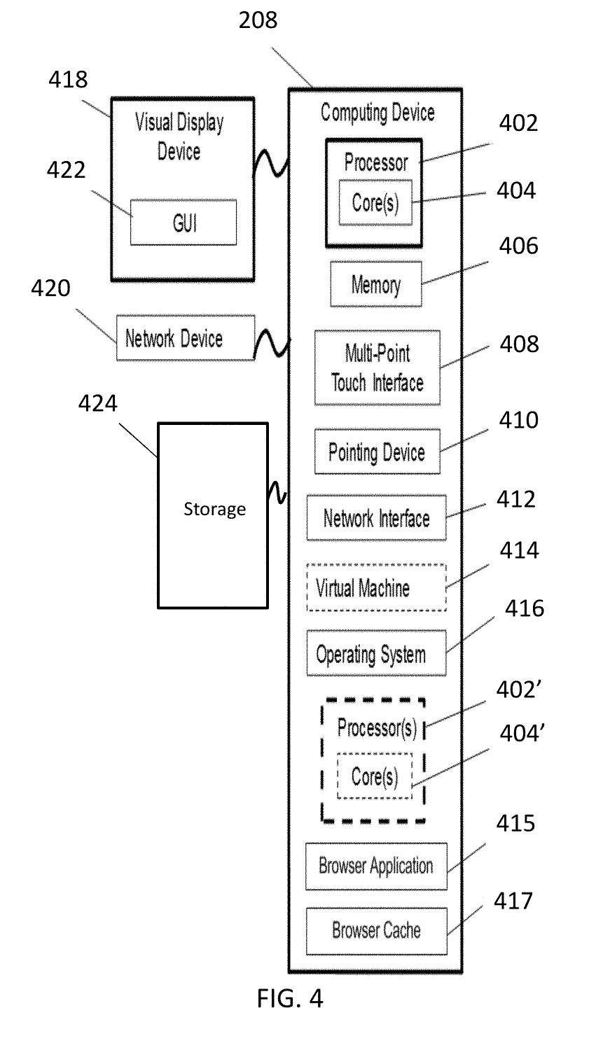

FIG. 4 is a schematic view of a computing system 208 suitable for use in embodiments. The computing system 208 includes one or more non-transitory computer-readable media for storing one or more computer-executable instructions or software for implementing exemplary embodiments. The non-transitory computer-readable media can include, but are not limited to, one or more varieties of hardware memory, non-transitory tangible media (for example, one or more magnetic storage disks, one or more optical disks, one or more USB flashdrives), and the like. For example, a memory 406 included in the computing system 208 can store computer-readable and computer-executable instructions or software for implementing exemplary embodiments. The computing system 208 also includes a processor 402 and an associated core 404, and optionally, one or more additional processor(s) 402′ and associated core(s) 404′ (for example, in the case of computer systems having multiple processors/cores), for executing computer-readable and computer-executable instructions or software stored in memory 406 and other programs for controlling system hardware. Processor 402 and processor(s) 402′ can each be a single core processor or multiple core (404 and 404′) processor.

Memory 406 includes a computer system memory or random access memory, such as DRAM, PGAM, EDO RAM, and the like. Memory 606 can include other varieties of memory as well, or combinations thereof. The computing system 208 includes secondary memory 424, such as a hard disk, hard-drive, CD-ROM, or other computer readable media, for storing employee action items. Secondary memory 424 may include one or more storage devices. In some embodiment, the secondary memory 424 may be used for storing any suitable information required to implement exemplary embodiments.

The computing system 208 can include a network interface 412 configured to interface via one or more network devices 422 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 412 can include a built-in network adapter, network interface card, PCMCIA network card, card bus network adapter, wireless network adapter, USB network adapter, modem or any other device suitable for interfacing the computing system 208 to any variety of network capable of communication and performing the operations described herein. Moreover, the computing system 208 can be any computer system, such as a workstation, desktop computer, server, laptop, handheld computer, tablet computer (e.g., the iPad® tablet computer), mobile computing or communication device (e.g., the iPhone® communication device), or other form of computing or telecommunications device that is capable of communication and that has sufficient processor power and memory capacity to perform the operations described herein.

The computing system 208 can run any operating system 416, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, any operating systems for mobile computing devices, or any other operating system capable of running on the computing device and performing the operations described herein. In exemplary embodiments, the operating system 416 can be run in native mode or emulated mode. In an exemplary embodiment, the operating system 416 can be run on one or more cloud machine instances.

In some embodiments, the computing system 208 may include a browser application. The browser application can enable a user to employee action items. For example, in some embodiments, a user can interact with the computing system 208 through a visual display device, such as a touch screen display or computer monitor, which can display one or more user interfaces that can be provided in accordance with exemplary embodiments. Visual display device may also display other aspects, elements and/or information or data associated with exemplary embodiments. The computing system 208 may include other I/O devices for receiving input from a user, for example, a keyboard or any suitable multi-point touch interface, a pointing device (e.g., a pen, stylus, mouse, or trackpad). The keyboard and pointing device may be coupled to visual display device. The computing system 208 may include other suitable conventional I/O peripherals.

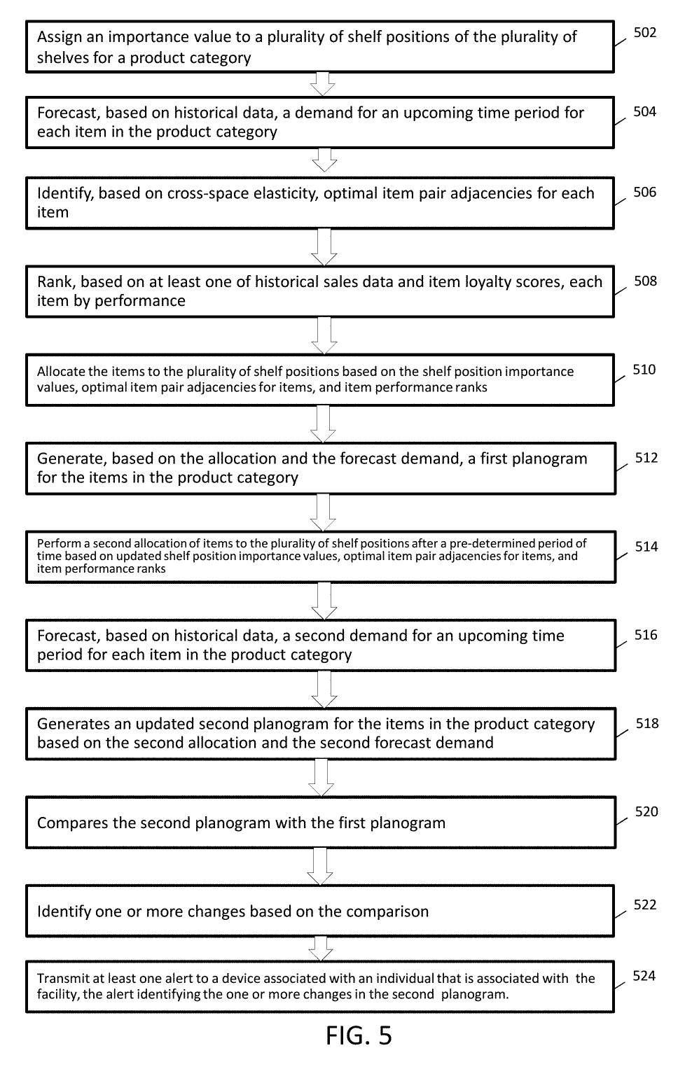

FIG. 5 is a flowchart depicting an exemplary sequence of steps for generating planograms in an exemplary embodiment. The exemplary sequence of steps are preforming using a computing device equipped with a memory and a processor and configured to execute a planogram generation (PG) module. At step 502, the computing device assigns an importance value to a plurality of shelf positions of the plurality of shelves for a product category. At step 504, the computing device forecasts, based on historical data, a demand for an upcoming time period for each item in the product category. At step 506, the computing device identifies, based on cross-space elasticity, optimal item pair adjacencies for each item. At step 508, the computing device ranks, based on at least one of historical sales data and item loyalty scores, each item by performance At step 510, the computing device allocates the items to the plurality of shelf positions based on the shelf position importance values, optimal item pair adjacencies for items, and item performance ranks. At step 512, the computing device generates, based on the allocation and the forecast demand, a first planogram for the items in the product category. At step 514, the computing device performs a second allocation of items to the plurality of shelf positions after a pre-determined period of time based on updated shelf position importance values, optimal item pair adjacencies for items, and item performance ranks. At step 516, the computing device forecasts, based on historical data, a second demand for an upcoming time period for each item in the product category. At step 518, the computing device generates an updated second planogram for the items in the product category based on the second allocation and the second forecast demand. At step 520, the computing device compares the second planogram with the first planogram. At step 522, the computing device identifies one or more changes based on the comparison. At step 524, the computing device transmits at least one alert to a device associated with an individual that is associated with the facility, the alert identifying the one or more changes in the second planogram.

The description herein is presented to enable any person skilled in the art to create and use a computer system configuration and related method and systems for generating a planogram. Various modifications to the example embodiments is readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention may be practiced without the use of these specific details. In other instances, well-known structures and processes are shown in block diagram form in order not to obscure the description of the invention with unnecessary detail. Thus, the present disclosure is not intended to be limited to the embodiments shown, but is to be accorded the widest scope consistent with the principles and features disclosed herein.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps can be replaced with a single element, component or step. Likewise, a single element, component or step can be replaced with a plurality of elements, components or steps that serve the same purpose. Moreover, while exemplary embodiments have been shown and described with references to particular embodiments thereof, those of ordinary skill in the art will understand that various substitutions and alterations in form and detail can be made therein without departing from the scope of the invention. Further still, other aspects, functions and advantages are also within the scope of the invention.

Exemplary flowcharts are provided herein for illustrative purposes and are non-limiting examples of methods. One of ordinary skill in the art will recognize that exemplary methods can include more or fewer steps than those illustrated in the exemplary flowcharts, and that the steps in the exemplary flowcharts can be performed in a different order than the order shown in the illustrative flowcharts.

We claim:

1. A system for planogram generation for a facility, the system comprising:
a physical facility with a plurality of shelves configured to hold a plurality of items;
a computing device equipped with a memory and a processor and configured to execute a planogram generation (PG) module that when executed:
assigns an importance value to a plurality of shelf positions of the plurality of shelves for a product category;
forecasts, based on historical data, a demand for an upcoming time period for each item in the product category;
identifies, based on cross-space elasticity, optimal item pair adjacencies for each item;
ranks, based on at least one of historical sales data and item loyalty scores, each item by performance;
allocates the items to the plurality of shelf positions based on the shelf position importance values, optimal item pair adjacencies for items, and item performance ranks;
generates, based on the allocation and the forecast demand, a first planogram for the items in the product category;
performs a second allocation of items to the plurality of shelf positions after a pre-determined period of time based on updated shelf position importance values, optimal item pair adjacencies for items, and item performance ranks;
forecasts, based on historical data, a second demand for an upcoming time period for each item in the product category;
generates an updated second planogram for the items in the product category based on the second allocation and the second forecast demand;
compares the second planogram with the first planogram;
identifies one or more changes based on the comparison; and
transmits at least one alert to a device associated with an individual that is associated with the facility, the alert identifying the one or more changes in the second planogram.

2. The system of claim 1, wherein the PG module when executed transmits the at least one alert to a facility manager for changing product placement or transmits the at least one alert to a replenishment manager for changing an order quantity in an order.

3. The system of claim 1, wherein the assignment of the importance value is based on the average height of a prime customer group for the product category, a position of a shelf, a depth and a width of the shelf, and past sales data of items in various shelf positions.

4. The system of claim 1, wherein the PG module when executed forecasts the demand for the upcoming time period for each item in a category by:
retrieving at least three years of point of sales data from the memory; and
using at least one of a SARIMAX analysis or a Holt-Winters method on the point of sales data to forecast sales.

5. The system of claim 1, wherein the PG module when executed identifies optimal item pair adjacencies by:
performing, for each item in the category, a multivariate regression on a facings allocated to the items in the category;
utilizing partial regression coefficients from the multivariate regression to identify a best complimentary item, wherein a sign of a coefficient is used to identify a set of complimentary items and a magnitude determines a best compliment;
placing the partial regression coefficients in an item-item adjacency matrix as estimates of cross-space elasticity to form a directed graph; and
determining optimal item pair adjacencies in the directed graph using a greedy algorithm, wherein adjacent items are displayed in the updated planogram.

6. The system of claim 1, wherein the importance value is assigned to a shelf position based on historical sales data and demographic importance associated with the shelf position.

7. The system of claim 1, wherein the PG module when executed generates the first and second planograms by:
creating starting and ending coordinates on the shelf positions obtained for each item with required facings; and
generating the automated planogram using an image plotting tool e.g. JDA.

8. The system of claim 1, the system further comprising a mobile application, the PG module when executed:
transmits the at least one alert to a mobile application executing on a mobile computing device associated with the individual that is associated with the facility, the alert including at least one of an image of the updated automated planogram or a required order amount to meet the forecasted demand.

9. The system of claim 1, the PG module when executed:
compares the existing first planogram with the updated second planogram and determines if there is statistically significant change in sales between the two planograms using machine learning; and
transmits the at least one alert when there is statistically significant change.

10. The system of claim 1, the system further comprising:
a drone configured to capture pictures of the plurality of shelves, the pictures used by the system to compare the updated second planogram with the plurality of shelves to identify one or more changes.

11. A method for planogram generation for a facility, the method comprising;
assigning, by a computing device equipped with a memory and a processor and configured to execute a planogram generation (PG) module, an importance value to a plurality of shelf positions of a plurality of shelves for a product category, wherein the plurality of shelves are configured to hold a plurality of items;
forecasting, by the computing device, based on historical data, a demand for an upcoming time period for each item in the product category;
identifying, by the computing device, based on cross-space elasticity, optimal item pair adjacencies for each item;
ranking, by the computing device, based on at least one of historical sales data and item loyalty scores, each item by performance;
allocating, by the computing device, the items to the plurality of shelf positions based on the shelf position importance values, optimal item pair adjacencies for items, and item performance ranks;
generating, by the computing device, based on the allocation and the forecast demand, a first planogram for the items in the product category;
performing, by the computing device, a second allocation of items to the plurality of shelf positions after a pre-determined period of time based on updated shelf position importance values, optimal item pair adjacencies for items, and item performance ranks;
forecasting, by the computing device, based on historical data, a second demand for an upcoming time period for each item in the product category;
generating, by the computing device, an updated second planogram for the items in the product category based on the second allocation and the second forecast demand;
comparing, by the computing device, the second planogram with the first planogram;
identifying, by the computing device, one or more changes based on the comparison; and
transmitting, by the computing device, at least one alert to a device associated with an individual that is associated with the facility, the alert identifying the one or more changes in the second planogram.

12. The method of claim 11, further comprising transmitting, by the computing device, the at least one alert to a facility manager for changing product placement or transmits the at least one alert to a replenishment manager for changing an order quantity in an order.

13. The method of claim 11, wherein the assignment of the importance value is based on the average height of a prime customer group for the product category, a position of a shelf, a depth and a width of the shelf, and past sales data of items in various shelf positions.

14. The method of claim 11, further comprising forecasting the demand for the upcoming time period for each item in a category by:
retrieving, by the computing device, at least three years of point of sales data from the memory; and
using, by the computing device, at least one of a SARIMAX analysis or a Holt-Winters method on the point of sales data to forecast sales.

15. The method of claim 11, further comprising identifying optimal item pair adjacencies by:
performing, by the computing device, for each item in the category, a multivariate regression on a facings allocated to the items in the category;
utilizing, by the computing device, partial regression coefficients to identify a best complimentary item, wherein a sign of a coefficient is used to identify a set of complimentary items and a magnitude determines a best compliment;
placing, by the computing device, the partial regression coefficients in an item-item adjacency matrix as estimates of cross-space elasticity to form a directed graph; and
determining, by the computing device, optimal item pair adjacency using a greedy algorithm, wherein adjacent items are displayed in the updated planogram.

16. The method of claim 11, wherein the importance value is assigned to a shelf position based on historical sales data and demographic importance associated with the shelf position.

17. The method of claim 11, further comprising generating, by the computing device, the first and second planograms by:
creating starting and ending coordinates on the shelf positions obtained for each item with required facings; and
generating the automated planogram using an image plotting tool e.g. JDA.

18. The method of claim 11, further comprising:
transmitting, by the computing device, the at least one alert to a mobile application executing on a mobile computing device associated with the individual that is associated with the facility, the alert including at least one of an image of the updated automated planogram or a required order amount to meet the forecasted demand

19. The method of claim 11, further comprising:
comparing, by the computing device, the existing first planogram with the updated second planogram and determines if there is statistically significant change in sales between the two planograms using machine learning; and
transmits the at least one alert when there is statistically significant change.

20. The method of claim 11, further comprising:
utilizing a drone configured to capture pictures of the plurality of shelves, the pictures used by the system to compare the updated second planogram with the plurality of shelves to identify one or more changes.
